(19) United States
(12) Patent Application Publication
(10) Pub. No.: US 2005/0271093 A1
(43) Pub. Date: Dec. 8, 2005

(54) Method and system for multiplying the repetition rate of a pulsed laser beam

(76) Inventor: Shamino Y. Wang, San Jose, CA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/860,302

(22) Filed: Jun. 3, 2004

(51) Int. Cl. H01S 3/10

(52) U.S. Cl. 372/25

(57) ABSTRACT

A system and method for increasing a repetition rate of an optical pulse train. The system includes a pulsed source configured to generate the optical pulse train and a cyclic demultiplexer configured to process the optical pulse train and output an output optical pulse train on each of a number of output ports. Each of the output optical pulse trains has a final repetition rate that is a multiple of the repetition rate corresponding to the optical pulse train generated by the pulsed source.

### TECHNICAL FIELD

The present invention relates to optical transmission systems. In particular, the present invention relates to the generation of a pulsed laser beam used in optical transmission systems.

### BACKGROUND

With advances in technology, there is a continuous demand to increase data transmission rates and the volume of data transmission. Traditional communication lines, such as copper wires, have been used to meet this continuous demand. However, traditional communication lines are subject to many disadvantages including limited bandwidth and high signal attenuation, which imposes distance limitations. In addition, traditional communication lines are susceptible to interference during the transmission of data. An example of interference includes, but is not limited to, electromagnetic interference.

Optical transmission systems using optical fibers overcome many shortcomings of traditional communication lines. Communication via optical fibers is characterized by immunity to electromagnetic interference, long transmission range, and high bandwidth. In fact, telecommunication networks that use optical fibers typically have several Terahertz (THz) of bandwidth available for data transmission.

Pulsed laser beams are often used in optical transmission systems. In many optical transmission system applications, it is desirable that the pulsed laser beam has a high repetition rate. The repetition rate may be defined as the rate at which a laser delivers pulses. For example, some optical systems such as those that utilize high speed optical time division multiplexing (OTDM) may require pulsed laser beams with a repetition rate in the Terahertz range.

However, many pulsed laser beam sources are incapable of emitting a pulsed laser beam with such a high repetition rate. The limitation in their repetition rates is primarily due to optical pulse power restrictions and the speed of optical modulators. Fabry-Perot cavities and optoelectronic pulse shapers have been used to externally increase the repetition rate. However, these techniques involve the use of complex hardware and/or are sensitive to frequency drift.

Another technique known as optical pulse interleaving has also been used to multiply the repetition rate of a pulsed laser beam. Optical pulse interleaving divides an input pulse train into two, and then recombines the two pulse trains with a delay. However, pulse interleaving requires the use of interferometric stabilization of the interleaving delay such that the phase coherence between the pulses is lost.

### SUMMARY

In one of many possible embodiments, the present invention provides a system and method for increasing a repetition rate of an optical pulse train. The system includes a pulsed source configured to generate the optical pulse train and a cyclic demultiplexer configured to process the optical pulse train and output an output optical pulse train on each of a number of output ports. Each of the output optical pulse trains has a final repetition rate that is a multiple of the repetition rate corresponding to the optical pulse train generated by the pulsed source.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates an optical pulse train emitted from a pulsed source in the time domain and the optical pulse train's corresponding frequency comb in the frequency domain according to one exemplary embodiment.

FIG. 2 illustrates the concept of repetition rate multiplication according to one exemplary embodiment.

FIG. 3 illustrates that a pair of wavelength division multiplexers (WDMs) may be used to multiply the repetition rate of the optical pulse train generated by the pulsed source according to one exemplary embodiment.

FIG. 4 shows a cyclic demultiplexer that is being used to multiply the repetition rate of an optical pulse train generated by the pulsed source according to one exemplary embodiment.

FIG. 5 is a flow chart illustrating an exemplary method of increasing the repetition rate of an optical pulse train according to one exemplary embodiment.

Throughout the drawings, identical reference numbers designate similar, but not necessarily identical, elements.

### DETAILED DESCRIPTION

An system and method for multiplying the repetition rate of a pulsed laser beam are explained herein. A pulsed source is configured to generate the pulsed laser beam. The pulsed laser beam is also referred to as an optical pulse train. A cyclic demultiplexer is configured to process the optical pulse train and output an output optical pulse train on each of a number of output ports. Each of the output optical pulse trains has a final repetition rate that is a multiple of the repetition rate corresponding to the optical pulse train generated by the pulsed source.

In the following description, for purposes of explanation, numerous specific details are set forth in order to provide a thorough understanding of the present system and method. It will be apparent, however, to one skilled in the art that the present system and method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

As used herein and in the appended claims, the terms “pulsed laser beam” and “optical pulse train” will be used interchangeably to refer to a pulsed laser or light beam generated by a pulsed source. The pulsed source may be a passively mode-locked Er-fiber laser or any other device configured to output a pulsed laser beam or a pulsed light beam, for example. The optical characteristics of the optical pulse train may vary as best serves a particular application. For example, in some applications, the optical pulse train generated by the pulsed source may have a spectral full width at half maximum (FWHM) of 50 nanometers, a temporal FWHM of 160 femptoseconds (fs), an initial repetition rate of 40 megahertz (MHz), and an average output power in free space of 50 milliwatts.

The pulsed laser beam, as will be recognized by one of ordinary skill in the art, is made up of a number of channels, or frequencies. Each frequency has a corresponding wavelength. These wavelengths, as will be explained below, may be separated by a wavelength division multiplexer (WDM) or by a cyclic demultiplexer. In other words, a WDM or a cyclic demultiplexer may demultiplex a pulsed laser beam into a number of separate light beams each having a different wavelength.

FIG. 1 illustrates an optical pulse train (100) emitted from a pulsed source in the time domain and the optical pulse train's (100) corresponding frequency comb (101) in the frequency domain. As shown in FIG. 1, the optical pulse train (100) includes a number of pulses (e.g.; 102) that are emitted from the pulsed source. Each pulse (102) is separated from the next pulse by a period T. In other words, the pulse train (100) has a frequency spacing F, where F=1/T. Thus, as shown in FIG. 1, the phase coherent modes or comb lines (e.g.; 103) of the frequency comb (101) with frequency spacing F produce a pulse train (100) with period T=1/F.

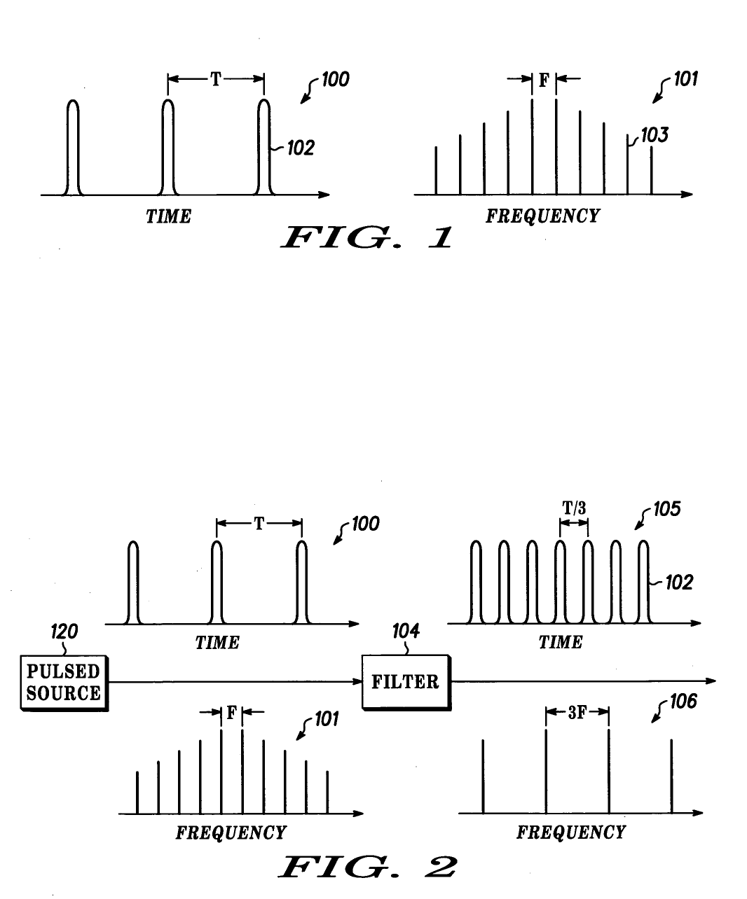

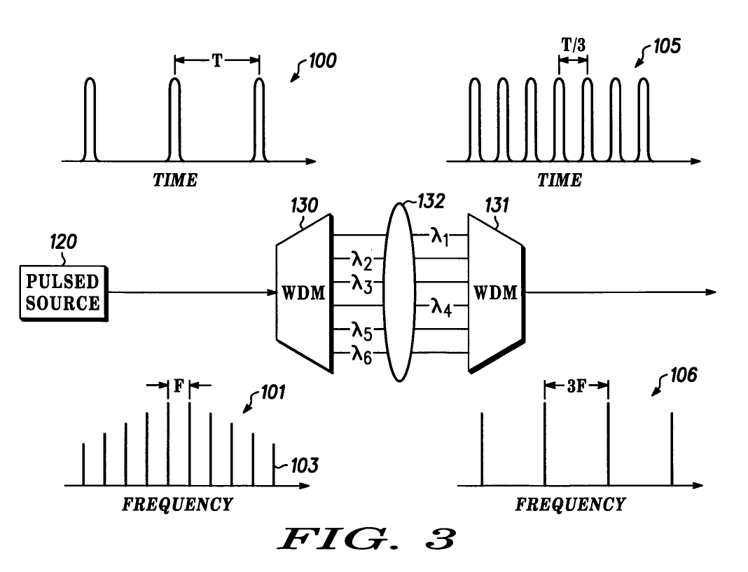

FIG. 2 serves as a general overview of the concept of repetition rate multiplication according to an exemplary embodiment of the present invention. As shown in FIG. 2, a pulsed source (120) may output an optical pulse train (100) with period T. The optical pulse train's (100) corresponding frequency comb (101) with frequency spacing F is also shown. The optical pulse train (100) may be passed through a spectral filter (104) with a free spectral range (FSR) that is an integral multiple of F. The result of passing the optical pulse train through the filter (104) is that the repetition rate of the resultant optical pulse train (105) is multiplied by the integral multiple. For example, as shown in FIG. 2, the filter (104) may pass only modes with frequency spacing 3F. The resultant optical pulse train (105), as shown in FIG. 2, has a period of T/3 and a frequency comb (106) having a frequency spacing of 3F. Hence, the repetition rate of the optical pulse train (100) is multiplied by a factor of three.

A filter (104) is used in the example of FIG. 2 for illustrative purposes only. As will be described below, devices and/or components other than traditional filters may be used to multiply the repetition rate of an optical pulse train.

FIG. 3 illustrates that a pair of wavelength division multiplexers (WDMs) (130, 131) may be used to multiply the repetition rate of the optical pulse train (100) generated by the pulsed source (120). As shown in FIG. 3, the optical pulse train (100) may be input into a first WDM (130). The first WDM (130) separates, or demultiplexes, the optical pulse train (100) into a number of light beams each of different wavelengths (λ₁-λ₆). Although the first WDM (130) separates the optical pulse train (100) into six light beams in the example of FIG. 3, it will be understood that the first WDM (130) may separate the optical pulse train (100) into any number of light beams each of different wavelengths.

As shown in FIG. 3, the separated light beams each of different wavelengths (λ₁-λ₆) are then input into an attenuator (132) which is configured to selectively pass some of the separated light beams to a second WDM (131). In the example of FIG. 3, two (λ₁, λ₄) of the six light beams are passed through to the second WDM (131).

The second WDM (131) recombines, or multiplexes, the separated light beams that have been allowed to pass through the attenuator (132). The second WDM (131) then outputs an output optical pulse train (105) comprising only the wavelengths (λ₁, λ₄) that have been allowed to pass through the attenuator (132). In this case, because the output optical pulse train (105) includes light having only two (λ₁, λ₄) of the six wavelengths (λ₁-λ₆) output by the first WDM (130), the output optical pulse train (105) has a repetition rate that is three times the repetition rate of the input optical pulse train (100).

A system that uses two WDMs (130, 131) to multiply the repetition rate of a pulsed laser beam, as described in connection with FIG. 3, may have to compensate for the insertion loss created by the two WDMs (130, 131). Furthermore, the second WDM (131) only outputs an output optical pulse train (105) with a multiplied repetition rate on one port. In other words, as illustrated in FIG. 3, all of the light beams having wavelengths (λ₂, λ₃, λ₅, λ₆) that are not passed through the attenuator (132) are wasted unless they are sent to additional WDMs. These additional WDMs may result in added insertion loss, system complexity, and cost.

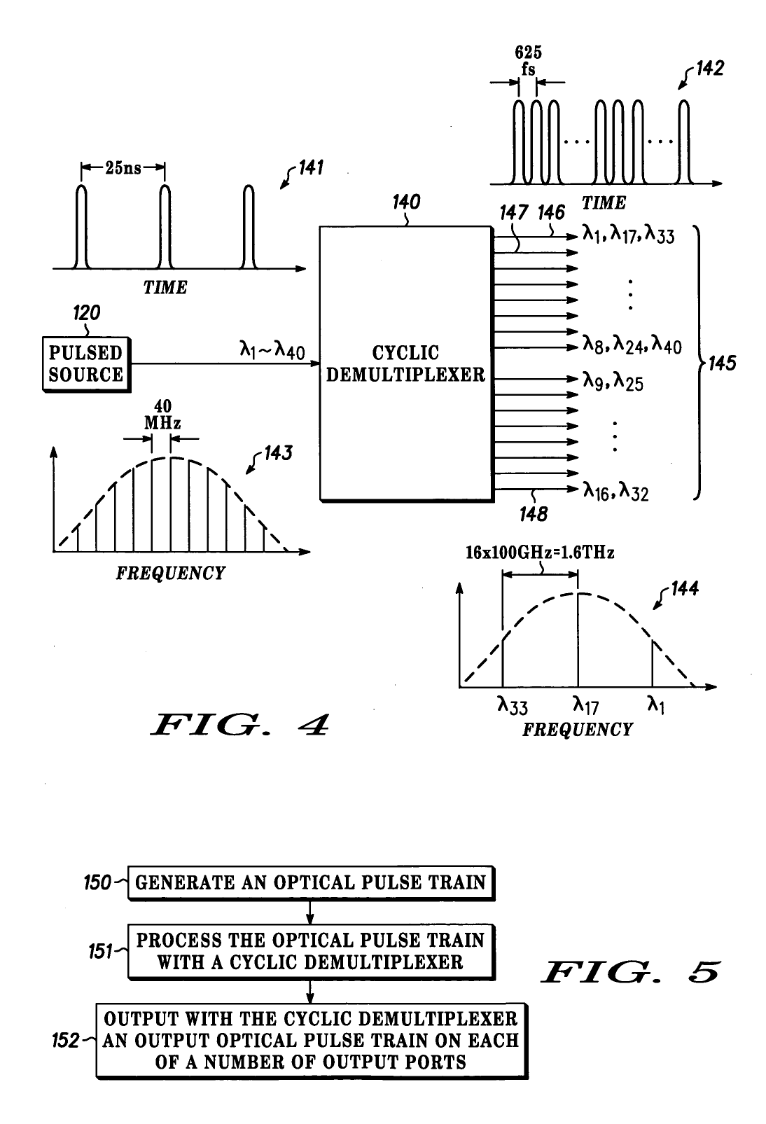

FIG. 4 illustrates an embodiment of the present invention wherein a cyclic demultiplexer (140) is used to multiply the repetition rate of an optical pulse train (141) generated by the pulsed source (120). The optical pulse train's corresponding frequency comb (143) is also shown in FIG. 4. The optical pulse train (141), as shown in FIG. 4, has a period T of 25 nanoseconds and a frequency spacing F of 40 MHz for illustrative purposes only. According to an exemplary embodiment, the pulsed source (120) may be configured to output an optical pulse train (141) having any size of frequency spacing.

As shown in FIG. 4, the optical pulse train (141) may be input into a cyclic demultiplexer (140). Cyclic demultiplexers are also known as colorless arrayed waveguide gratings (AWGs) and cyclic AWGs. Thus, as used herein and in the appended claims, the terms cyclic demultiplexer, colorless AWG, and cyclic AWG will be used interchangeably. Cyclic demultiplexers are known in the art and will not be explained in detail in the present specification.

As shown in FIG. 4, an exemplary cyclic demultiplexer (140) may be configured to receive and demultiplex an optical pulse train (141) having a number of channels, or frequencies. For example, the optical pulse train (141) may have 40 channels each with different wavelengths. Hence, as shown in FIG. 4, the optical pulse train (141) may be represented by a signal having 40 wavelengths (λ₁-λ₄₀). The cyclic demultiplexer (140) may be configured to demultiplex, or separate, these 40 wavelengths (λ₁-λ₄₀) and cyclically output the wavelengths on a number of output ports (145). In other words, each output port (145) outputs a number of evenly spaced channels.

For example, the cyclic demultiplexer (140) of FIG. 4 is configured to demultiplex 40 wavelengths (λ₁-λ₄₀) and cyclically output the wavelengths on sixteen output ports (145). The cyclic demultiplexer (140) of FIG. 4 has sixteen output ports (145) for illustrative purposes only. However, the cyclic demultiplexer (140) may have four, eight, or any other number of output ports according to an embodiment of the present invention. As shown in FIG. 4, the cyclic demultiplexer (140) outputs λ₁ on the first output port (146), λ₂ on the second output port (147), and so on until λ₁₆ is output on the sixteenth output port (148). The cyclic demultiplexer (140) then cycles through the ports again, outputting λ₁₇ on the first output port (146), λ₁₈ on the second output port (147), and so on. This cyclic process continues until all of the wavelengths (λ₁-λ₄₀) are output by the cyclic demultiplexer (140), as shown in FIG. 4.

The individual wavelengths that are output on a particular output port make up an output optical pulse train (142). Thus, each of the sixteen output ports (145) of the cyclic demultiplexer (140) outputs a separate optical pulse train (142). For example, the first output port (146) outputs an optical pulse train (142) that is made up of the wavelengths λ₁, λ₁₇, and 33, the second output port (147) outputs an optical pulse train (142) that is made up of the wavelengths λ₂, λ₁₈, and λ₃₄, and so on. As will be described below, each output optical pulse train (142) has a faster repetition rate than the repetition rate of the input optical pulse train (141).

The individual wavelengths that are output on a particular output port are evenly spaced by a frequency spacing, or channel spacing, that is determined by the configuration of the cyclic demultiplexer (140). In one exemplary embodiment, the frequency spacing between each channel (i.e. between λ₁ and λ₂) is 100 gigahertz (GHz). However, the frequency spacing between each channel may be 10 GHz, 50 GHz, or any other frequency spacing that the cyclic demultiplexer (140) is configured to produce. Hence, the final frequency spacing, or the final repetition rate, of the output optical pulse train (142), as shown by the frequency comb (144) in FIG. 4, is 16×100 GHz, or 1.6 Terahertz (THz). The frequency comb (144) corresponds to the optical pulse train (142) output by the first output port (146) of the cyclic demultiplexer (140). However, the frequency combs produced by the other output ports have identical frequency spacings. Thus, each output port (145) of the cyclic demultiplexer (140) outputs an optical pulse train (142) having a repetition rate of 1.6 THz, or a multiplication factor of 40,000 times the 40 MHz repetition rate of the input optical pulse train (141).

The multiplication factor will vary depending on the frequency spacing of the input optical pulse train (141) and on the configuration of the cyclic demultiplexer (140). For example, if the input optical pulse train (141) has a frequency spacing of 1 GHz and the cyclic demultiplexer (140) is configured as explained in connection with FIG. 4, the multiplication factor is equal to 1.6 THz/1 GHz=1600.

In one exemplary embodiment, an equalization device, such as a threshold detector, and/or a saturable device, such as a semiconductor optical amplifier (SOA), may be used to compensate for, or equalize, unequal output peak amplitudes of the output optical pulse train (142).

The cyclic demultiplexer (140) of FIG. 4 is a stand-alone device and may be inserted into or removed out of the path of the optical pulse train (142) that is generated by the pulsed device (120) at will, according to an exemplary embodiment. Moreover, a single cyclic demultiplexer (140) device may be inserted into the optical pulse train path with minimal insertion loss. On the other hand, a system using multiple WDMs (e.g. 130, 131; FIG. 3) will suffer multiple insertion losses depending on the number of WDMs that are used in the system.

Furthermore, as mentioned above, a cyclic demultiplexer (140) outputs on each output port (145) an optical pulse train (142) with a repetition rate that has been multiplied by the same multiplication factor. On the other hand, in a system using multiple WDMs (e.g. 130, 131; FIG. 3), the second WDM (131) only outputs an output optical pulse train (105) with a multiplied repetition rate on one port. In other words, as illustrated in FIG. 3, all of the light beams having wavelengths (λ₂, λ₃, λ₅, λ₆) that are not passed through the attenuator (132) are wasted unless they are sent to additional WDMs. These additional WDMs may result in added insertion loss, system complexity, and cost.

FIG. 5 is a flow chart illustrating an exemplary method of increasing the repetition rate of an optical pulse train according to an exemplary embodiment. As shown in FIG. 5, an optical pulse train (141; FIG. 4) is first generated (step 150). The optical pulse train (141; FIG. 4) has an initial repetition rate. Next, the optical pulse train (141; FIG. 4) is processed by a cyclic demultiplexer (140) (step 151). The step of processing the optical pulse train (141; FIG. 4) (step 151) may include separating the optical pulse train (141; FIG. 4) into a number of light beams each having a different wavelength and cyclically outputting each of the light beams on the cyclic demultiplexer's output ports (145). Finally, an output optical pulse train (142; FIG. 4) is output on each of a number of output ports (145) of the cyclic demultiplexer (140) (step 152).

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

1. A system for increasing a repetition rate of an optical pulse train, said system comprising:
a pulsed source configured to generate said optical pulse train; and
a cyclic demultiplexer configured to process said optical pulse train and output an output optical pulse train on each of a number of output ports;
wherein each of said output optical pulse trains has a final repetition rate that is a multiple of said repetition rate corresponding to said optical pulse train generated by said pulsed source.

2. The system of claim 1, wherein said number of output ports is sixteen, eight, or four.

3. The system of claim 1, wherein said cyclic demultiplexer is further configured to:
separate said optical pulse train generated by said pulsed source into a number of light beams each having a different wavelength; and
cyclically output each of said light beams on said output ports.

4. The system of claim 1, wherein each of said output optical pulse trains comprises a series of pulses separated by a frequency spacing.

5. The system of claim 4, wherein said frequency spacing is equal to one hundred gigahertz multiplied by said number of output ports, fifty gigahertz multiplied by said number of output ports, or ten gigahertz multiplied by said number of output ports.

6. The system of claim 1, further comprising an equalization device configured to equalize unequal output peak amplitudes of one or more of said output optical pulse trains.

7. The system of claim 6, further comprising a saturable device configured to equalize unequal peak amplitudes of one or more of said output optical pulse trains.

8. An output optical pulse train generated by a cyclic demultiplexer, said output optical pulse train having a final repetition rate that is a multiple of an input repetition rate corresponding to an input optical pulse train, said input optical pulse train being input into said cyclic demultiplexer.

9. A method of increasing an initial repetition rate of an optical pulse train, said method comprising:
generating said optical pulse train;
processing said optical pulse train with a cyclic demultiplexer; and
outputting with said cyclic demultiplexer an output optical pulse train on each of a number of output ports;
wherein each of said output optical pulse trains has a final repetition rate that is a multiple of said initial repetition rate.

10. The method of claim 9, wherein said number of output ports is sixteen, eight, or four.

11. The method of claim 9, wherein said step of processing said optical pulse train with said cyclic demultiplexer comprises:
separating said optical pulse train having said initial repetition rate into a number of light beams each having a different wavelength; and
cyclically outputting each of said light beams on said output ports.

12. The method of claim 9, wherein each of said output optical pulse trains comprises a series of pulses separated by a frequency spacing.

13. The method of claim 12, wherein said frequency spacing is equal to one hundred gigahertz multiplied by said number of output ports, fifty gigahertz multiplied by said number of output ports, or ten gigahertz multiplied by said number of output ports.

14. The method of claim 9, further comprising:
equalizing unequal output peak amplitudes of one or more of said output optical pulse trains.

15. A system for increasing an initial repetition rate of an optical pulse train, said method comprising:
means for generating said optical pulse train;
means for processing said optical pulse train; and
means for outputting multiple output optical pulse trains;
wherein each of said output optical pulse trains has a final repetition rate that is a multiple of said initial repetition rate.

16. The system of claim 15, wherein said multiple output optical pulse trains comprises sixteen, eight, or four optical pulse trains.

17. The system of claim 15, wherein said means for processing said optical pulse train comprises:
means for separating said optical pulse train having said initial repetition rate into a number of light beams each having a different wavelength; and
means for cyclically outputting each of said light beams on a number of output ports.

18. The system of claim 15, further comprising:
means for equalizing unequal output peak amplitudes of one or more of said output optical pulse trains.
